(19) United States
(12) Patent Application Publication
(10) Pub. No.: US 2007/0280773 A1
(43) Pub. Date: Dec. 6, 2007

(54) Securable cap medication dispenser

(76) Inventor: Darren S. Warren, Clemmons, NC (US)

Correspondence Address: Charles Y. Lackey, PO Box 5871, Winston-Salem, NC, 27113-5871, US

(21) Appl. No.: 11/446,704

(22) Filed: Jun. 5, 2006

(51) Int. Cl. B43K 5/06

(52) U.S. Cl. 401/175

(57) ABSTRACT

A medication dispenser has a base, an elevating rod fastened to the base and a housing. The base has an engaging tab and a removable cap. A product supporting shelf engages the elevating rod which has a spirally formed engaging ridge (or groove). The product supporting shelf has an elevating rod spirally formed ridge-receiving groove (or ridge) formed therein. The base rotates to raise and lower the product-supporting shelf. When the base is at the lowest position, the engaging tab lines up with tab-engaging slot, the two are urged together to place the tab within the slot to secure the housing to the base.

### BACKGROUND OF THE INVENTION

1. Field of the Invention

The present invention relates to a medication or appearance enhancing cosmetic dispensing container and, more particularly, to such a container which can be secured to prevent cap/base separation or movement when not in use.

2. Description of the Prior Art

Numerous types of containers for products like lip balm, lipstick, deodorant, sun screen or the like are known in the art. One known device includes a housing having an open end, a threaded stem, a fingerwheel mounted to the stem for rotating the stem, and a follower threadably engaged with the stem that is adapted to move axially within the container in response to rotation of the fingerwheel. The follower is adapted to slide between a retracted position and a dispensing position. Manually turning or twisting the fingerwheel in a first direction causes the follower to act as a plunger and push a leading edge of the product out of the open end of the housing for application. Turning the fingerwheel in a second direction (the reverse direction) causes the follower to move axially in a reverse direction toward the retracted position and pull the leading edge of the product inside the housing.

One problem associated with this device is that it can become inoperative if the follower is in its retracted position and then finger wheel is turned in the second direction (the reverse direction). Because the follower is unable to move further, further turning of the fingerwheel can cause the stem, the follower or any of the threads of the stem or follower to strip or fracture or can otherwise cause the container to become inoperative.

This problem can arise during a first use of the container since sticking of the product to the housing tends to occur prior to first use and since, as a result, an increased twisting force is usually necessary to turn the follower. If the increased twisting force is exerted in the wrong direction, it will likely cause the container to fail.

Another problem that has been noted occurs when the chapstick container is inserted into a pants pocket. Movement of the container in the pocket sometimes causes the fingerwheel to turn thereby raising the medication in the tube into the cap.

Accordingly, there is a need to provide a dispenser that addresses these problems, and is to that need that the present invention is directed.

### SUMMARY

In accordance with a preferred embodiment of the invention, a dispenser for medication or appearance enhancement products (“product”) is provided that includes a base, a housing, an elevating rod fixed secured to the base with the base having an engaging tab formed therein and a removable cap. A product supporting shelf operably engages the elevating rod. The elevating rod has a spirally formed engaging ridge (or groove), and the product-supporting shelf has an elevating rod spirally formed ridge receiving groove (or ridge) formed therein. The base is rotatable to cause the elevating rod to raise and lower the product-supporting shelf when the cap is removed. When the base is rotated to bring the product-supporting shelf to the lowest position, the engaging tab aligns with the tab-engaging slot, axial movement terminates and the cap and base can be urged together vertically to position the tab within the slot and thereby secure the housing to the base.

The shelf preferably includes an internally threaded central core which is in threaded engagement with the elevating rod, although the threads on the rod and shelf may be reversed. The housing is thin-walled, and the elevating rod threads extend downwardly stopping just before reaching the base. When the base is rotated to retract the product within the housing, movement is stopped just before the elevating rod reaches the base and at a location where the housing tab-engaging slot is in alignment with the base engaging tab. The base and housing are urged together so that the tab is received within the housing tab-engaging slot and no movement can occur between the two members until the base is pulled away from the housing.

Thus there has been outlined the more important features of the invention in order that the detailed description that follows may be better understood and in order that the present contribution to the art may be better appreciated. There are, of course, additional features of the invention that will be described hereinafter and which will form the subject matter of the claims appended hereto. In that respect, before explaining at least one embodiment of the invention in detail, it is to be understood that the invention is not limited in its arrangement of the components set forth in the following description and illustrated in the drawings. The invention is capable of other embodiments and of being practiced and carried out in various ways.

It is also to be understood that the phraseology and terminology employed herein are for the purpose of description and should not be regarded as limiting in any respect. Those skilled in the art will appreciate that the concept upon which this disclosure is based may readily be utilized as a basis for designing other structures, methods and systems for carrying out the several purposes of this development. It is important that the claims be regarded as including such equivalent methods and products resulting therefrom that do not depart from the spirit and scope of the present invention. The application is neither intended to define the invention, which is measured by its claims, nor to limit its scope in any way.

Thus, the objects of the invention set forth above, along with the various features of novelty which characterize the invention, are noted with particularity in the claims annexed to and forming a part of this disclosure. For a better understanding of the invention, its operating advantages and the specific results obtained by its use, reference should be made to the following detailed specification taken in conjunction with the accompanying drawings wherein like characters of reference designate like parts throughout the several views.

The drawings are included to provide a further understanding of the invention and are incorporated in and constitute a part of this specification. They illustrate embodiments of the invention and, together with their description, serve to explain the principles of the invention.

### DETAILED DESCRIPTION OF THE DRAWINGS

FIG. 1 is a perspective view of a dispenser including the present invent in the fully closed and capped condition;

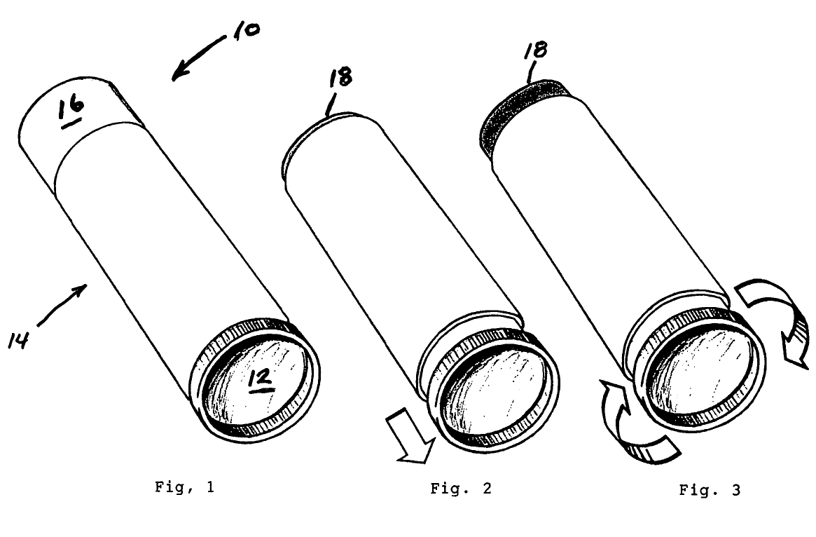

FIG. 2 is a perspective view of the dispenser shown in FIG. 1 with the cap removed and the base slightly rotated to start the product emerging from the housing;

FIG. 3 is a perspective vie of the dispenser shown in FIGS. 1 and 2 whereing rotation of the base has continued and the product has emerged to a useable position outside the housing;

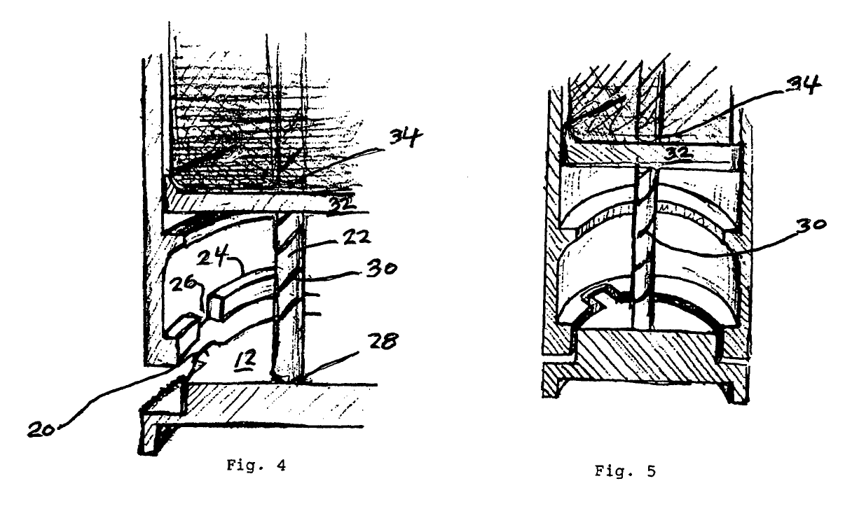

FIG. 4 is an elevational, partial and fragmentary view of the dispenser of the present invention showing the base separated from the housing to place the dispenser in operable condition; and

FIG. 5 is an elevational, partial and fragmentary view of the dispenser of the present invention showing the base tab nesting within the housing tab-receiving slot to place the dispenser in an inoperable condition.

### DETAILED DESCRIPTION OF PREFERRED EMBODIMENT

Referring now to the drawings and particularly to FIG. 1, the dispenser shown generally as 10 includes a base 12 compatibly connected with a housing 14 and closed when not in use by a cap 16. When cap 16 is removed and dispenser 10 is readied for use, base 12 is withdrawn from its secure connection with housing 14 as shown in FIG. 2, the operation to be described in more detail subsequently. The contained substance 18 to be applied commences its movement out of housing 14 with that withdrawing movement.

Base 12 is then rotated, preferably in a clockwise direction, as shown in FIG. 3 to move substance 18 outwardly from housing 14. As will be described in detail, rotating base 12 in a counterclockwise direction urges substance 18 back into housing 14 until it is completely contained. When counterclockwise rotation is restrained, base 12 is then urged toward housing 14 and snaps into the locked position where no rotation between base 12 and housing 14 can take place.

The internal structure of dispenser 10 comprising the present invention is shown in FIGS. 4 and 5. In the closed and locked position as shown in FIG. 1, the internal configuration of the dispenser is as shown in FIG. 5. Base 12 has an engaging tab 20 extending radially from an elevating rod 22. The internal structure of housing 14 contains a circumferential ridge 24 in which is formed an engaging slot 26. Elevating rod 22 is fixedly secured to base at location 28. Elevating rod 22 has a spirally formed engaging ridge 30.

A medication or other substance supporting shelf 32 has an aperture 34 in its center which has a spirally configured grove in its internal surface (not shown) that is compatible and mates with elevating rod spirally formed engaging ridge 30 so that rotation of base 12 in a clockwise direction causes the cooperatively connected engaging ridge 30 and housing internal surface configured groove to move supporting shelf 32 and carried substance 18 upwardly and out of housing 14. When base 12 and housing are in the closed position as shown in FIGS. 1 and 5, no rotation of the base can occur because tab 20 is within engaging slot 26. When base 12 is pulled away from housing 14, tab 20 is removed from engaging slot 26 and thus allows base 12 and elevating rod 22 to rotate in response to clockwise rotation.

The present invention provides assurance that dispenser cannot experience rotational and perhaps damaging movement when it is in the non-operative condition which could otherwise occur if a locking system as described is not in place.

From the preceding description, it can be seen that a locking medication dispenser has been provided that will meet all of the advantages of prior art devices and offer additional advantages not heretofore achievable. With respect to the foregoing invention, the optimum dimensional relationship to the parts of the invention including variations in size, materials, shape, form, function, and manner of operation, use and assembly are deemed readily apparent to those skilled in the art, and all equivalent relationships illustrated in the drawings and described in the specification are intended to be encompassed herein.

The foregoing is considered as illustrative only of the principles of the invention. Numerous modifications and changes will readily occur to those skilled in the art, and it is not desired to limit the invention to the exact construction and operation shown and described. All suitable modifications and equivalents that fall within the scope of the appended claims are deemed within the present inventive concept.

What is claimed is:

1. A locking medication dispenser comprising: a base; a housing; a cap; an elevating rod fixedly secured to the base, the base having an engaging tab formed therein, a medication supporting shelf operably engaging the elevating rod, the housing having a tab engaging slot formed therein, the base being rotatable to cause the elevating rod to raise and lower the medication supporting shelf when the cap is removed and the base engaging tab engages the housing receiving slot when the supporting shelf is in the lowest position to prevent further movement of the shelf with respect to the base.

2. The dispenser as claimed in claim 1 wherein the elevating rod has a spirally formed engaging ridge.

3. The dispenser as claimed in claim 1 wherein the supporting shelf has an elevating rod spirally formed ridge-receiving groove formed therein.

4. The dispenser as claimed in claim 1 wherein the elevating rod has a spirally formed ridge-engaging groove.

5. The dispenser as claimed in claim 1 wherein the supporting shelf has an elevating rod spirally formed ridge formed therein.

6. The dispenser as claimed in claim 1 wherein the base is freely rotatable when the supporting shelf is in the lowest position.

7. The dispenser as claimed in claim 6 wherein the base is rotated to align the base-engaging tab with the housing tab-engaging slot, urged toward the housing and thereby fixedly secure the cap to the base and prevent movement of the medication supporting shelf.

8. The dispenser as claimed in claim 7 wherein the base is moved away from the housing separate the base-engaging tab from the housing tab-engaging slot and permit rotational movement of the cap with respect to the base.
